(19) United States
(12) Patent Application Publication
(10) Pub. No.: US 2009/0250327 A1
(43) Pub. Date: Oct. 8, 2009

(54) STEERING COLUMN MODULE AND ASSOCIATED ASSEMBLY METHOD

(75) Inventors: NICOLAS TUAL, STRASBOURG (FR); MICHAEL BIACCHI, LOCHWILLER (FR)

Correspondence Address: DELPHI TECHNOLOGIES, INC., M/C 480-410-202, PO BOX 5052, TROY, MI, 48007, US

(73) Assignee: DELPHI TECHNOLOGIES, INC., TROY, MI (US)

(21) Appl. No.: 12/410,653

(22) Filed: Mar. 25, 2009

(30) Foreign Application Priority Data
Apr. 3, 2008 (EP) 08154042.9

(51) Int. Cl. H01H 9/00

(52) U.S. Cl. 200/61.54

(57) ABSTRACT

The invention proposes a steering column module intended to be mounted on a steering column, in particular of a motor vehicle, including a casing on which is mounted a rotary electrical connector which comprises a rotor and a stator, of the type including an angular indexing sleeve which is moveable between an indexing position in which it locks the rotor in a determined angular position relative to the stator, and a neutral position in which the rotor can rotate relative to the stator, wherein said module includes a detachable cover which is arranged on the so as to cover the upper axial end section of the indexing sleeve in order to prevent access to the indexing sleeve.

### TECHNICAL FIELD

The present invention relates to a steering column module and a method for mounting this module on a motor vehicle steering column.

### BACKGROUND OF THE INVENTION

The present invention relates more particularly to a steering column module which comprises a casing or support on which a rotary electrical connector is mounted and which is intended to be mounted on a steering column. A steering column module of such a type is in particular described in the document FR2829071.

The rotary electrical connector, also called a clockspring connector, is a device providing electrical connection between two respectively fixed and moveable bodies having a relative movement of rotation. Such a device is used in vehicle steering columns to permit electrical connection between elements situated in the steering-wheel, and consequently moveable in rotation, and a fixed circuit wired in the passenger space of the said vehicles.

A rotary electrical connector is so configured that the fixed part, called the stator, and the moveable part, called the rotor, between them define an annular space having an axis coinciding with the axis of rotation, in which is spirally wound a flexible flat cable carrying a plurality of conductive lines. In particular, this annular space includes two walls parallel with the axis of rotation to which are fixed the two ends of the flat cable.

An example of such a rotary electrical connector is described and illustrated in more detail in the document EP1320153.

The rotary electrical connector is generally pre-assembled on the casing, and then the complete steering column module is conveyed to the assembly line where it is mounted on the steering column. During this conveyance phase, it is necessary to lock the rotor in rotation relative to the stator, so that it is maintained in a median angular position or “midpoint” corresponding to the median angular position of the steering column on which it is to be mounted.

This rotational locking is effected by means of an indexing sleeve which is arranged coaxially within the rotary electrical connector, which is attached in rotation to the rotor and which includes angular indexing means co-operating with a fixed part of the module. For example, the indexing sleeve includes an indexing finger which can co-operate with an associated indexing notch arranged on a fixed part such as the stator. The indexing sleeve is mounted axially slidingly in the rotary electrical connector and is axially biased towards its indexing position, upwardly, by a spring.

The indexing sleeve is normally sufficient to lock the rotor in rotation until it is mounted on the column. On mounting of the steering-wheel on the column, the indexing sleeve is pushed back axially downwardly, against its spring, into a neutral position, so that the indexing finger leaves its indexing notch and the rotor is free in rotation relative to the stator.

However, between the step of pre-assembly of the steering column module and the step of mounting on the steering column, it happens that the indexing sleeve is accidentally displaced into its neutral position, which leads to uncertainty about the angular position of the rotor on mounting of the steering-wheel, wheel, maintenance of the rotor in its median position no longer being assured. The consequences can be that, after mounting of the steering-wheel on the column, the flexible electrical conductor, which extends in the radial space between the rotor and the stator, can turn back on itself when the steering-wheel reaches full left lock, or can even be torn when the steering-wheel reaches full right lock.

To resolve this problem, it has been proposed to mount a locking key on the casing. This key is fixed to the casing and it has stop surfaces which co-operate with lugs provided on the peripheral edge of the rotor to lock it angularly. Thus, even if the indexing sleeve is accidentally displaced, the rotor is still kept in its median position by the locking key. The key can be removed once the steering column module is mounted on the steering column, just before mounting of the steering-wheel.

### SUMMARY OF THE INVENTION

The present invention is intended to propose an alternative to the locking key which allows perfect angular indexing of the rotor relative to the stator to be ensured until it is mounted on the column.

To this end, the invention proposes a steering column module of the type mentioned above which includes a detachable cover which is arranged on the steering column module so as to cover the upper axial end section of the indexing sleeve in order to prevent access to the indexing sleeve.

The cover in accordance with the invention allows access to be prevented to the indexing sleeve between the step of assembly of the steering column module and the step of mounting of the steering-wheel on the steering column. In particular, In particular, access to the indexing sleeve is prevented during the steps of conveying the module to the line for mounting on the steering column. Access to the indexing sleeve is only permitted at the last moment, just before mounting of the steering-wheel. The cover thus acts as a security pin.

In addition to allowing angular indexing of the rotor relative to the stator, the invention provides improved axial guiding of the module when it is mounted on the column. If fact, on mounting of the steering column module on the column, the internal tubular partition of the protection cover centres and axially aligns the module relative to the steering column. Previously, with the solutions of the prior art, due to manufacturing tolerances, particularly for the diameter of the steering column, it frequently happened that the steering column module was mounted with an unwanted incline to the axis of the steering column.

In accordance with other characteristics of the invention:
the cover includes snap fitting means to detachably fix it onto an element of the steering column module;
the snap fitting means co-operate with complementary means arranged on the rotary electrical connector;
the snap fitting means are arranged on an external tubular partition of the cover which is inserted axially between the rotor and the indexing sleeve;
the cover includes axial guiding means which co-operate with a portion of the steering column to guide the module when it is mounted on the steering column;
the axial guiding means consist of an internal tubular partition which is intended to co-operate with a portion of the steering column;
the cover includes a gripping means allowing traction to be applied to the cover to withdraw it from the module.

The invention also proposes a method for mounting a steering column module and a steering-wheel on a steering column, the steering column module being made in accordance with the above teachings, characterised in that it includes the following steps:
axial mounting of the module on the upper axial end section of the steering column using the cover as a means for axial guiding and axial alignment of the module relative to the column,
withdrawal of the cover,
mounting of the steering-wheel on the column, axially sliding the indexing sleeve into its neutral position releasing the rotor in rotation.

### BRIEF DESCRIPTION OF THE DRAWINGS

Other characteristics, aims and advantages of the invention will become apparent on reading the following detailed description in comparison with the attached drawings, given by way of non-limiting example and in which:

FIG. 1 is an exploded perspective view showing a steering column module including a cover in accordance with the invention;

FIG. 2 is a view in axial section which shows the module of FIG. 1;

FIG. 3 is a perspective view which shows the cover of FIG. 1.

### DESCRIPTION OF THE PREFERRED EMBODIMENTS

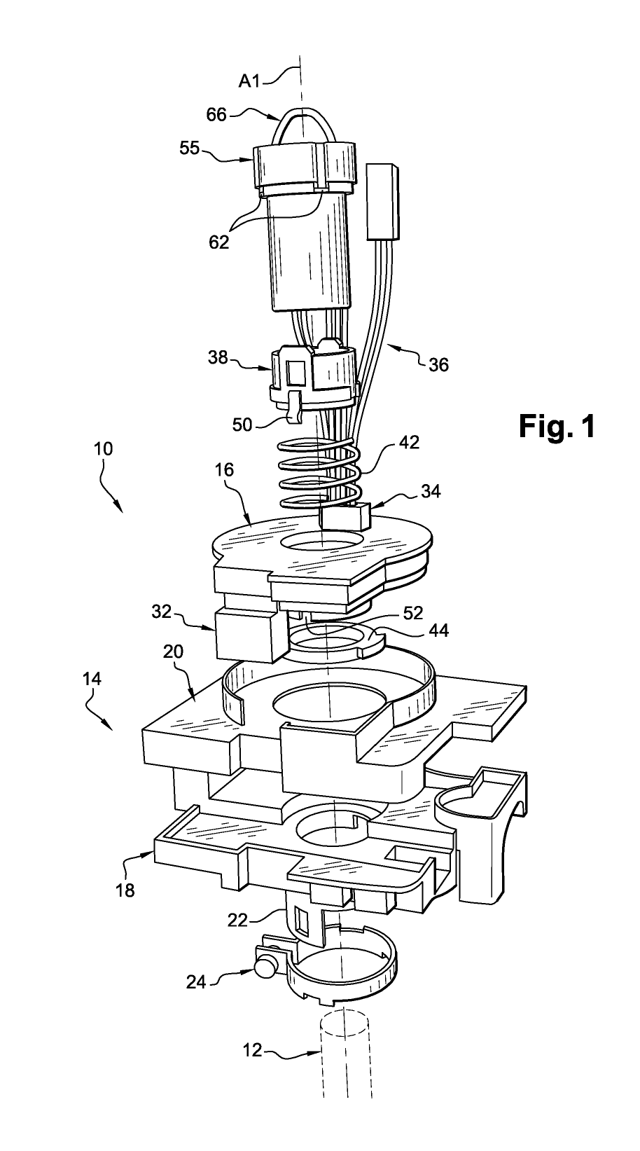

FIG. 1 shows a steering column module 10 formed in accordance with the teachings of the invention and intended to be mounted co-axially on a steering column 12 of axis A1. It includes a casing 14 or support on which is mounted a rotary electrical connector 16.

In the remainder of the description, in non-limiting manner, a vertical orientation along the axis A1 of the steering column 12 will be employed.

The casing 14 here includes a lower shell 18 and an upper shell 20 which are fixed one on the other. The upper face of the upper shell 20 forms a plate which receives the rotary electrical connector 16. The lower shell 18 includes a lower tubular extension 22 which is intended to be mounted on a section of the steering column 12 and held by means of a clamping collar 24.

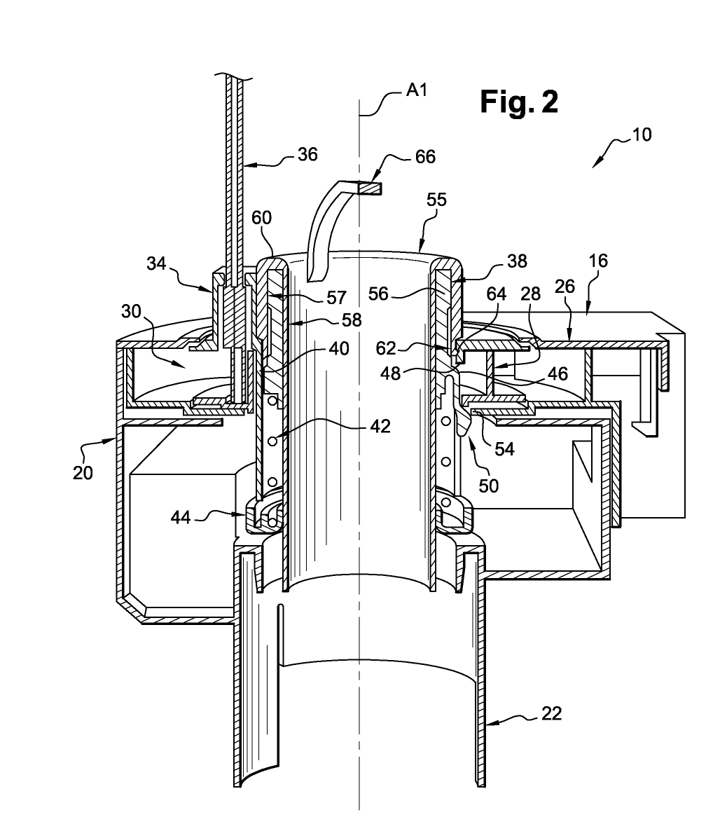

As shown in more detail in FIGS. 1 and 2, the rotary electrical connector 16 includes a stator 26 which is fixed onto the upper shell 20 of the casing 14 and a rotor 28 which is rotatably mounted on the stator 26 defining a radial space 30 intended to receive flexible electrical conductors (not shown) connected on one side to a fixed connector 32 on the stator 26 and on the opposite side to a rotary connector 34 on the rotor 28. The rotary connector 34 is here provided with electrical cables 36 for connection to electronic devices (not shown) of the steering-wheel intended to be mounted on the column 12.

An indexing sleeve 38 is arranged coaxially within the rotary electrical connector 16. The indexing sleeve 38 is guided to slide axially along the internal axial wall 40 of the rotor 28. It is biased axially upwardly, i.e. towards its indexing position, by a spring 42 which bears against a lower cup 44 fixed in the casing 14. 14. The indexing sleeve 38 includes a radial surface 46 which bears axially against a stop surface 48 arranged on the rotor 28. The indexing sleeve 38 includes an indexing finger or clip 50 which extends radially through an axial slot 52 formed in the internal axial wall 40 of the rotor 28 and which is received, in its angular indexing position, in an indexing notch 54 formed in the internal peripheral wall of the stator 26.

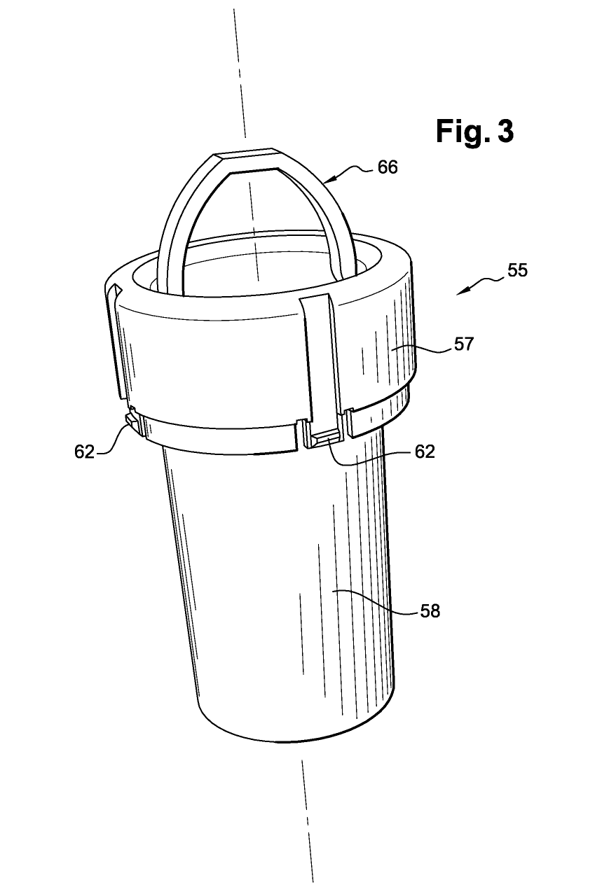

In accordance with the teachings of the invention, a detachable cover 55, which is shown in detail in FIG. 3, is arranged on the steering column module 10 so as to cover the upper axial end section 56 of the indexing sleeve 38. The cover 55 has a tubular form of axis A1 and includes an external axial partition 57 which is inserted axially between the rotor 28 and the indexing sleeve 38, and an internal axial partition 58 which extends along the internal axial wall of the indexing sleeve 38. The upper axial ends of the two partitions 57, 58 are joined by an annular radial wall 60.

Advantageously, the internal partition 58 extends axially as far as the lower tubular extension 22 of the casing 14 so as to prevent any access to the indexing sleeve 38 and to facilitate alignment guiding of the steering column module 10 on the steering column 12.

As shown in particular in FIG. 3, the external partition 57 of the cover 55 is provided with fixing lugs or clips 62 which co-operate with complementary housings 64 arranged in the internal peripheral edge of the rotor 28 to hold the cover 55 on the rotor 28 by interlocking or snap fitting.

Advantageously, the upper axial end of the cover 55 is provided with a handle 66 allowing upward axial traction to be applied, for example manually, to withdraw the cover 55 from the module 10 and thus release the indexing sleeve 38 to allow mounting of the steering-wheel on the steering column 12.

A method for assembling the steering column module 10 in accordance with the invention comprises the following steps:
assembly of the casing with the rotary electrical connector and the indexing sleeve, the rotor then being radially indexed relative to the stator by means of the indexing sleeve,
axial insertion of the cover 55 onto the indexing sleeve until the fixing lugs fit into the complementary housings.

At this stage, the steering column module is in a state in which access to the indexing sleeve is prevented by the cover 55.

The steering column module can thus be conveyed to the production line where it is mounted on the steering column without risk of accidental displacement of the indexing sleeve, and therefore without risk of angular offset between the rotor and the stator relative to the required median position.

The method for mounting the module 10 on the steering column comprises the following steps:
axial mounting of the module 10 on the upper axial end section of the steering column, the internal partition of the cover 55 contributing to axial guiding and axial alignment of the module 10 relative to the column,
withdrawal of the cover by traction applied to the cover by means of the handle,
mounting of the steering-wheel on the column by axial insertion from the top, through the module 10, which causes axial sliding of the indexing sleeve into a neutral position in which the indexing finger no longer co-operates with the associated notch of the stator.

1. A steering column module comprising:
a casing carrying a rotary electrical connector which comprises a rotor and a stator, of the type including an angular indexing sleeve which is moveable between an indexing position in which the rotor is locked in a determined angular position relative to the stator, and a neutral position in which the rotor can rotate relative to the stator,
wherein said module includes a detachable cover which is arranged on the steering column module so as to cover the upper axial end section of the indexing sleeve in order to prevent access to the indexing sleeve.

2. The module of claim 1, wherein the cover includes snap fitting means for fixing it detachably onto an element of the module.

3. The module of claim 2, wherein the snap fitting means co-operate with complementary means arranged on the rotary electrical connector.

4. The module of claim 3, wherein the snap fitting means are arranged on an external tubular partition of the cover which is axially inserted between the rotor and the indexing sleeve.

5. The module of claim 1, wherein the cover includes axial guiding means which co-operate with a portion of the steering column to guide the module when it is mounted on the steering column.

6. The module of claim 5, wherein the axial guiding means consist of an internal tubular partition which is intended to co-operate with a portion of the steering column.

7. The module of claim 1, wherein the cover includes a gripping means permitting traction to be applied to the cover to withdraw it from the module.

8. A method for mounting a steering column module and a steering-wheel on a steering column, the steering column module being formed in accordance with the teachings of claim 1, wherein said method includes the following steps:
axial mounting of the module on the upper axial end section of the steering column using the cover as a means for axial guiding and axial alignment of the module relative to the column,
withdrawal of the cover,
mounting of the steering-wheel on the column by axially sliding the indexing sleeve into its neutral position releasing the rotor in rotation.

9. An automotive steering column module comprising:
a casing adapted to be affixed to a relatively non-moving portion of an associated steering column;
a rotary electrical connector including a stator fixedly carried with said casing and a rotor carried for rotation with a moving portion of said associated steering column about an axis of rotation;
an angular indexing sleeve selectively displacable along said axis of rotation between an indexing position in which said sleeve is operative to interconnect said stator and rotor in a fixed orientation and a neutral position in which said sleeve which said sleeve releases said stator and rotor for relative rotational freedom therebetween, said sleeve having an exposed end portion extending externally of said casing;
means operative to continuously resiliently urge said angular indexing sleeve axially from said neutral position toward and indexing position; and
a detatchable cover configured to substantially encase the exposed end portion of said indexing sleeve and to releasably engage an element of said module to prevent displacement of said indexing sleeve from said indexing position.

10. The automotive steering column module of claim 9, wherein said detachable cover comprises concentrically disposed inner and outer axially extending partitions interconnected by an annular radial wall, said inner and outer partitions being radially spaced to receive the exposed end portion of the sleeve therebetween.
